(19) United States
(12) Patent Application Publication
(10) Pub. No.: US 2010/0244652 A1
(43) Pub. Date: Sep. 30, 2010

(54) Glass for IR Signature Reduction

(75) Inventors: Leslie Brandon Shaw, Woodbridge, VA (US); Jasbinder S. Sanghera, Ashburn, VA (US); Ishwar D. Aggarwal, Fairfax Station, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(73) Assignee: The Government of the United States of America Represented by the Secretary of the Navy, Washington, DC (US)

(21) Appl. No.: 12/409,833

(22) Filed: Mar. 24, 2009

(51) Int. Cl. H01J 5/00; F21V 9/04

(52) U.S. Cl. 313/317; 252/587

(57) ABSTRACT

A doped glass composition is provided. A base glass is doped with rare earth ions Terbium Tb³⁺ and Europium Eu³⁺ to produce a glass that reduces the transmission of short-wave infrared radiation therethrough without reducing the transmission of visible light. A base glass composition is doped with Tb³⁺ and Eu³⁺ ions to an appreciable concentration, in some embodiments in excess of 5 mol % and in other embodiments to a concentration in excess of 1 mol %. A suitable glass for doping according to the present invention includes any glass that can accept rare earth ions at appreciable densities such as the densities described above, and can include oxide-based, fluoride-based, and chalcogenide-based glasses. The doped glass attenuates transmission of short-wave infrared radiation having wavelengths of about 1.8 μm to about 2.5 μm and does not reduce transmission of visible light having wavelengths from about 0.4 μm to about 0.8 μm.

### TECHNICAL FIELD

The present invention relates to glasses and glass compositions.

### BACKGROUND

Glasses and glass compositions can be found in numerous modern devices. For example, automobiles are a key user of glass in their windows and windshields. Glass can be found in both low- and high-tech optical devices such as binoculars, scopes, rangefinders, and night-vision equipment. Glass also can be found in ordinary articles such as flashlights and lamps.

Glasses and glass compositions can be engineered to provide many useful and desirable characteristics. For example, glass compositions can provide useful optical characteristics such as the filtering or blocking of certain wavelengths of radiation in the electromagnetic spectrum while allowing other desired wavelengths to be transmitted therethrough.

It often may be desirable to block infrared (IR) radiation from a light source to protect the object emitting such radiation. For example, some weapons such as man-portable air-defense systems (MANPADS) utilize IR radiation to guide their weapons to the desired target. Landing lights on aircraft, both commercial and military, are a source of high-intensity IR radiation, and so can increase the susceptibility of these aircraft to such IR-seeking MANPADS. Many of these MANPAD systems are sensitive to short wave IR (SWIR) emissions having wavelengths between 1.8 and 2.5 μm. Thus, reduction of SWIR emissions by an object such as an aircraft landing light without reducing its transmission of visible light can increase the aircraft's protection from IR-seeking threats such as MANPADS while maintaining its ability to land safely.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter.

The present invention comprises a glass composition doped with the rare earth ions Terbium Tb³⁺ and Europium Eu³⁺ to create a glass which exhibits strong absorption of radiation in the short wave infrared (SWIR) band but has low absorption of visible light. The glass composition of the present invention can be fabricated into coverings for lamps such as those used in aircraft landing lights to reduce or block their emission of SWIR radiation and reduce the vulnerability of the aircraft to threats from heat-seeking weaponry. The glass also can be used as part of the lamp itself or be deposited as a coating on the lamp. The glass also can be used for any purpose in which reduction of SWIR radiation without reduction of visible light transmission is desired, such as windows for buildings or vehicles.

### BRIEF DESCRIPTION OF THE DRAWINGS

FIGS. 1A and 1B are plots showing the radiation absorption spectrum of Tb³⁺ and Eu³⁺ ions in glass.

FIG. 2 is a plot showing the absorption of infrared radiation in Tb³⁺ and Eu³⁺ doped glass versus undoped glass.

FIG. 3 is a plot showing the transmission of short wave infrared (SWIR) radiation through glass as a function of its Tb³⁺ and Eu³⁺ concentration.

FIGS. 4A and 4B depict exemplary uses of a Tb³⁺ and Eu³⁺ doped glass according to the present invention to block SWIR radiation from a lamp.

### DETAILED DESCRIPTION

The aspects summarized above can be embodied in various forms. The following description shows, by way of illustration, combinations and configurations in which the aspects can be practiced. It is understood that the described aspects and/or embodiments are merely examples. It is also understood that one skilled in the art may utilize other aspects and/or embodiments or make structural and functional modifications without departing from the scope of the present disclosure.

For example, although the glass composition of the present invention is often described in terms of its use in aircraft landing lights or to protect aircraft from heat-seeking weaponry, it can easily be appreciated that glass having the composition of the present invention can be used in many other applications where glass is used, such as in buildings and vehicles, and can be useful in any application where reduction of the transmission of SWIR radiation without reduction of the transmission of visible light is desired.

The present invention comprises a glass composition including a base glass doped with rare earth ions Terbium Tb³⁺ and Europium Eu³⁺ to produce a glass that reduces the transmission of SWIR radiation without reducing the transmission of visible light therethrough. In accordance with the present invention, the base glass is doped with Tb³⁺ and Eu³⁺ ions to an appreciable concentration, in some embodiments in excess of 5 mol % and in other embodiments to a concentration in excess of 1 mol %. In some embodiments, the glass is doped with an equal concentration of Tb³⁺ and Eu³⁺ ions, while in other embodiments, the Tb³⁺ and Eu³⁺ ions are added in different proportions.

A suitable base glass for doping according to the present invention includes any glass that can accept rare earth ions at appreciable densities such as the densities described above, and can include oxide-based, fluoride-based, chalcogenide-based glasses, and their mixtures. In addition, in some embodiments, the glass can also contain other rare earth elements such as Samarium (Sm³⁺), Praseodymium (Pr³⁺), Dysprosium (Dy³⁺) or Thulium (Tm³⁺) or transition metals ions such as Iron (Fe²⁺, Fe³⁺). The present invention takes advantage of the absorptive properties of the rare earth ions Terbium Tb³⁺ and Europium Eu³⁺. These ions exhibit strong absorption of radiation in the SWIR band, comprising wavelengths between 1.8 μm and 2.5 μm, but exhibit little absorption of visible light, which has much shorter wavelengths of from 0.36 μm to about 0.78 μm.

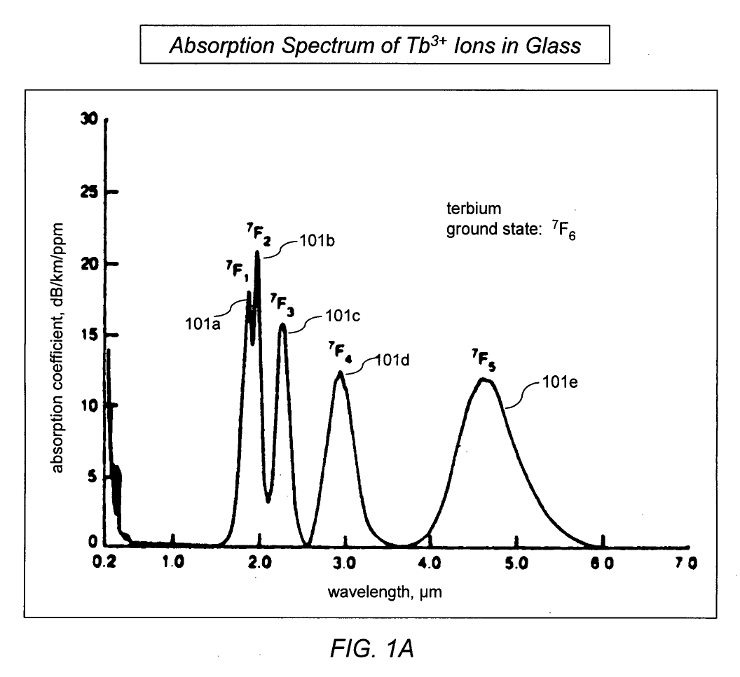

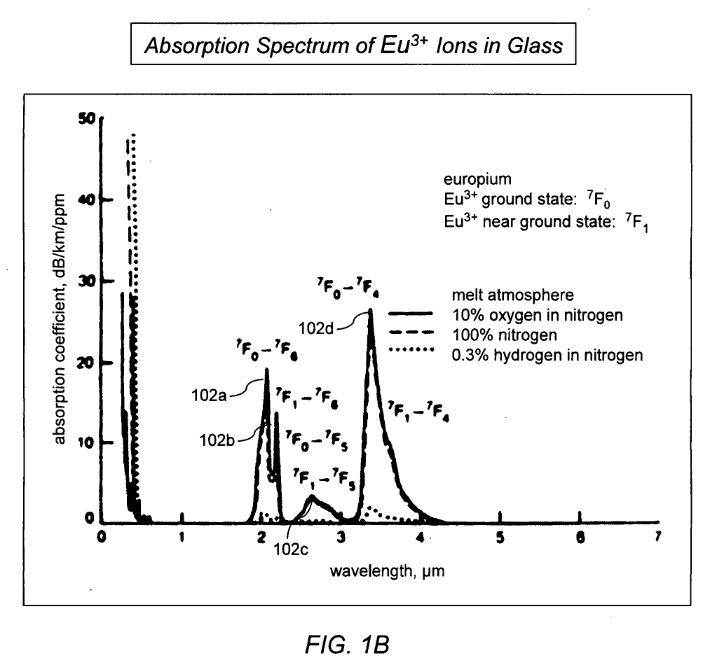

FIGS. 1A and 1B illustrate this property of Tb³⁺ and Eu³⁺ ions in glass by plotting the absorption coefficients (dB/km/ppm) of Tb³⁺ and Eu³⁺ at wavelengths from 0.2 to 7.0 μm, showing peaks at the wavelengths where absorption is highest. As seen in FIG. 1A, Terbium in the form of Tb³⁺ ions exhibits an absorption peak 101a at approximately 1.7 μm, a peak 101b at approximately 1.8 μm, a peak 101c at approximately 2.2 μm, a peak 101d at approximately 3.0 μm, and a peak 101e at approximately 4.5 μm. As seen in FIG. 1B, Europium in the form of Eu³⁺ ions exhibits absorption peaks 102a, 102b, 102c, and 102d defining the respective electron energy levels at approximately 2.0 μm, 2.2 μm, 2.6 μm, and 3.5 μm, respectively. All of the peaks in both plots are in the SWIR range. In addition, both plots show nearly zero absorption in the visible range of about 0.4 μm to about 0.8 μm.

Thus, it can be readily seen from the plots in FIGS. 1A and 1B, both Tb³⁺ and Eu³⁺ ions in glass exhibit strong absorptive properties for light in the SWIR range while showing little absorption (i.e., strong transmission) for light in the visible range.

The absorptive and transmittive properties of a Tb³⁺ and Eu³⁺ doped glass according to the present invention are further illustrated by way of the following examples.

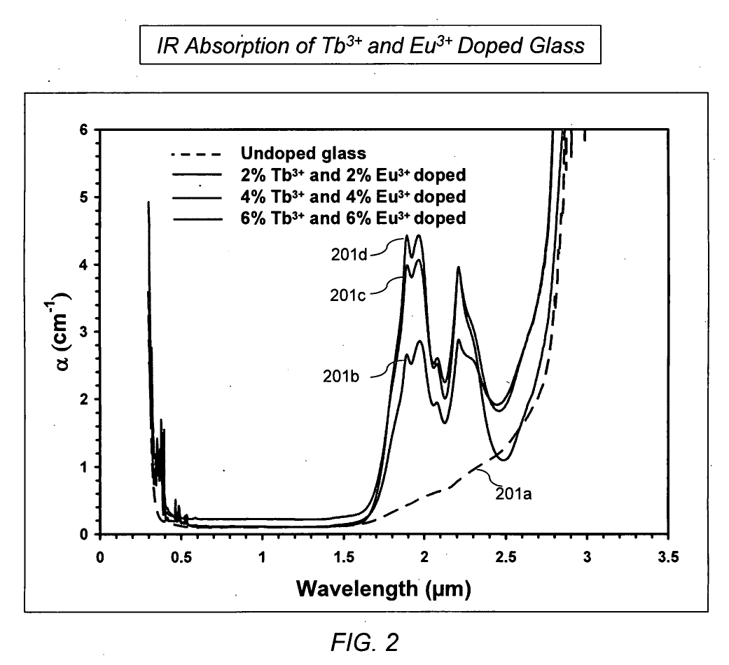

One-inch diameter samples of Tb³⁺ and Eu³⁺ doped phosphate glass windows were prepared. Dopant concentrations ranged from 0% (undoped) to 6% concentrations of each. The glasses were placed in front of the output of a standard aircraft landing light, in this case a PAR 64 aircraft landing light. The plots in FIG. 2 show the absorption of light in the visible to SWIR regions by the various glass compositions. The plots in FIG. 2 correspond to glass compositions which have been doped with 2% each of Tb³⁺ and Eu³⁺, 4% each of Tb³⁺ and Eu³⁺ and 6% each of Tb⁺ and Eu³⁺, as well as an undoped glass. As can be seen in FIG. 2, the plot 201a corresponding to the undoped glass demonstrates no spike in absorption in the SWIR wavelength range of 1.5 to 2.5 μm, while the doped glasses all show significant spikes in absorption, which increase with the level of doping. The smallest spike 201b is shown by the 2% doped glass, with a larger spike 201c corresponding to the 4% doped glass, and the largest spike 201d corresponding to the 6% doped glass. In all cases, there is little or no appreciable spike in the attenuation coefficient shown in the 0.4 to 0.8 μm visible light range. Thus, for all of the Tb³⁺ and Eu³⁺ doped glasses, transmission was sharply attenuated in the SWIR band>1.6 μm, while the visible band between 0.4 and 0.8 μm shows no appreciable attenuation.

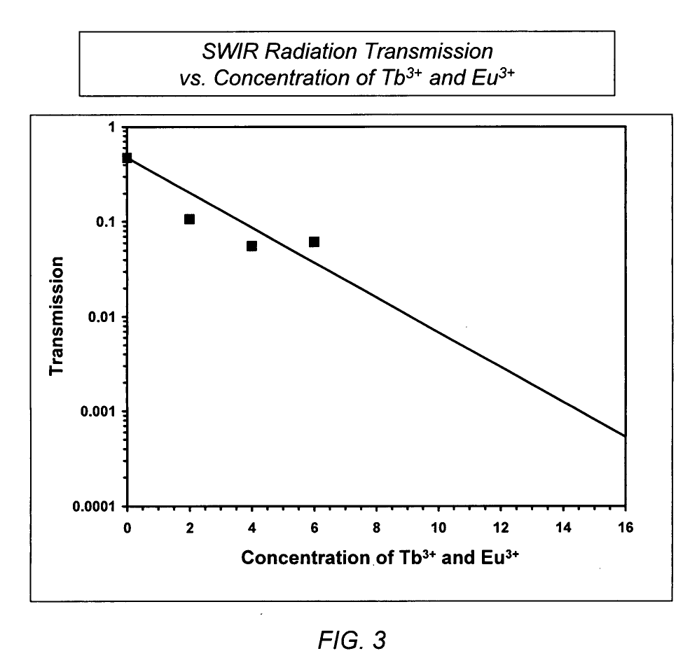

FIG. 3 further illustrates the SWIR blocking characteristics of Tb³⁺ and Eu³⁺ doped glasses. As seen in FIG. 3, the transmission of SWIR radiation through a glass correlates linearly with the Tb³⁺ and Eu³⁺ concentration in the glass, with the transmission of SWIR radiation decreasing as the Tb³⁺ and Eu³⁺ concentration increases, with a transmission coefficient of approximately 0.5 for an undoped glass to a transmission coefficient of less than 0.001 for an exemplary glass according to the present invention having a Tb³⁺ and Eu³⁺ concentration of 16%. In the exemplary embodiment of a Tb³⁺ and Eu³⁺ doped glass reflected in FIG. 3, the glass composition contains approximately 8% each of Tb³⁺ and Eu³⁺, but it should be noted that other proportions of Tb³⁺ to Eu³⁺ may also be used within the scope of the present disclosure.

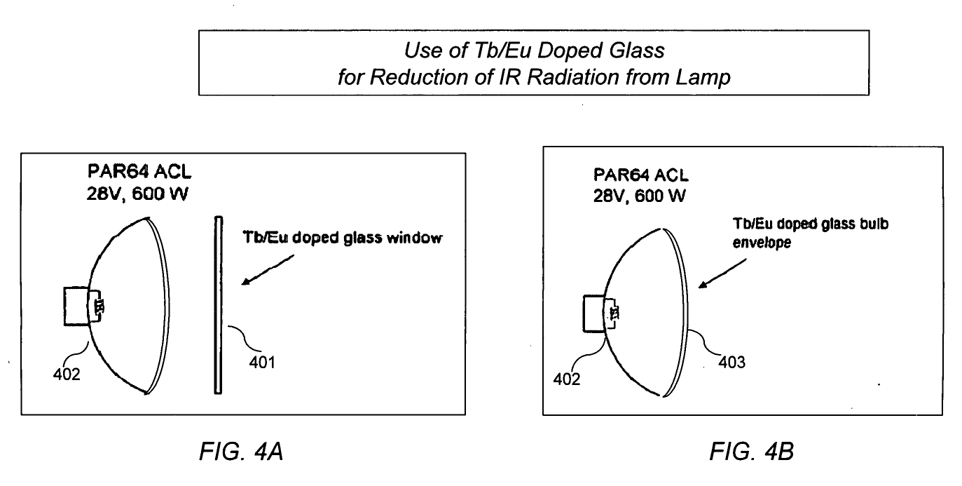

As described above, the Tb³⁺ and Eu³⁺ doped glass composition of the present invention can be fabricated into many glass products where reduction in the transmission of SWIR radiation is desirable. For example, the Tb³⁺ and Eu³⁺ glass of the invention can be used to shield aircraft landing lights to reduce their SWIR transmission signature and reduce their vulnerability to threats from heat-seeking weaponry. FIGS. 4A and 4B illustrate two exemplary ways in which the Tb³⁺ and Eu³⁺ doped glass of the invention can be used to shield lamps and reduce their transmission of SWIR radiation. In the exemplary configuration shown in FIG. 4A, a sheet 401 of a Tb³⁺ and Eu³⁺ doped glass is placed in front of a lamp 402. Such a configuration can be used, for example, with the glass forming a window in front an aircraft landing light. In the exemplary configuration shown in FIG. 4B, the Tb³⁺ and Eu³⁺ doped glass is used in the lamp 402 itself, forming the outer face 403 thereof. In other configurations (not shown), the glass of the invention may also be used as a coating on another sheet of glass, either as a window or as part of the lamp, or can even be used as part of the light bulb itself. In any of these cases, as shown in FIG. 2, the use of such a Tb³⁺ and Eu³⁺ doped glass can result in significant reduction in the SWIR emissions from the lamp. In addition, it is contemplated that because glasses having different Tb³⁺ and Eu³⁺ concentrations have different SWIR absorption, more than one layer of the Tb³⁺ and Eu³⁺ doped glass may be used, for example, both in the lamp and in a window surrounding the lamp, to reduce the SWIR emissions even further.

Thus a Tb³⁺ and Eu³⁺ rare earth ion doped glass has significant advantages over conventional glass. Currently, glasses used in aircraft landing light bulb envelopes and lamp windows do not attenuate the SWIR component of the emitted light. The SWIR spectral component of these lamps has been identified as a vulnerability of aircraft to MANPADS, and the glass of the present invention would eliminate this vulnerability without hindering the performance of the lamps. The glass of the invention is suitable for protecting both commercial and military aircraft. In addition, the glass of the invention is suitable for other uses where reduction of the SWIR component of the emitted light without reduction of visible light is desired.

Although particular embodiments, aspects, and features have been described and illustrated, it should be noted that the invention described herein is not limited to only those embodiments, aspects, and features. It should be readily appreciated that modifications may be made by persons skilled in the art, and the present application contemplates any and all modifications within the spirit and scope of the underlying invention described and claimed herein. Such embodiments are also contemplated to be within the scope and spirit of the present disclosure.

What is claimed is:

1. A glass composition, comprising:
a base glass doped with an appreciable concentration of Terbium Tb³⁺ ions and Europium Eu³⁺ ions to provide a doped glass;
wherein the transmission of short-wave infrared radiation through the doped glass is reduced as a result of the presence of the Tb³⁺ ions and Eu³⁺ ions; and
further wherein the transmission of visible light through the doped glass is not appreciably reduced.

2. The glass composition according to claim 1, wherein the combined concentration of the Terbium Tb³⁺ ions and Europium Eu³⁺ ions is at least one mole percent.

3. The glass composition according to claim 1, wherein the combined concentration of the Terbium Tb³⁺ ions and Europium Eu³⁺ ions is between one and five mole percent.

4. The glass composition according to claim 1, wherein the combined concentration of the Terbium Tb³⁺ ions and Europium Eu³⁺ ions is greater than five mole percent.

5. The glass composition according to claim 1, wherein the concentration of the Terbium Tb³⁺ ions and Europium Eu³⁺ ions is approximately equal.

6. The glass composition according to claim 1, wherein the glass is further doped with at least one of a rare earth element and a transition metal.

7. The glass composition according to claim 6, wherein the glass is further doped with at least one of Samarium (Sm³⁺), Praseodymium (Pr³⁺), Dysprosium (Dy³⁺), Thulium (Tm³⁺), Iron (Fe²⁺), and Iron Fe³⁺.

8. The glass composition according to claim 1, wherein the base glass comprises one of an oxide-based glass, a fluoride-based glass, a chalcogenide-based glass, and mixtures thereof.

9. The glass composition according to claim 1, wherein the doped glass reduces transmission of short-wave infrared radiation having wavelengths from about 1.8 μm to about 2.5 μm and does not appreciably reduce transmission of visible light having wavelengths from about 0.4 μm to about 0.8 μm.

10. A lamp assembly having reduced emission of short-wave infrared radiation without having appreciably reduced emission of visible light, comprising:
a lamp having at least one light bulb configured to emit electromagnetic radiation in the short wave infrared range and the visible light range of the electromagnetic spectrum, the light bulb having a first end connected to an electrical power source and a second end configured to emit the electromagnetic radiation therefrom, the light bulb being situated in a lamp housing, the lamp assembly including a substantially transparent face proximate to the second end of the light bulb;
wherein the substantially transparent face includes a doped glass having an appreciable concentration of Terbium Tb³⁺ ions and Europium Eu³⁺ ions;
wherein the transmission of short-wave infrared radiation through the doped glass is reduced as a result of the presence of the Terbium Tb³⁺ ions and Europium Eu³⁺ ions; and
further wherein the transmission of visible light through the doped glass is not appreciably reduced.

11. The lamp assembly according to claim 10, wherein the doped glass comprises a base glass composition doped with at the Terbium Tb³⁺ ions and the Europium Eu³⁺ ions.

12. The lamp assembly according to claim 11, wherein the base glass composition comprises one of an oxide-based glass, a fluoride-based glass, a chalcogenide-based glass, and mixtures thereof.

13. The lamp assembly according to claim 10, wherein the doped glass has a combined concentration of the Terbium Tb³⁺ ions and Europium Eu³⁺ ions of at least one mole percent.

14. The lamp assembly according to claim 10, wherein the doped glass has a combined concentration of the Terbium Tb³⁺ ions and Europium Eu³⁺ ions of between one and five mole percent.

15. The lamp assembly according to claim 10, wherein the doped glass has a combined concentration of the Terbium Tb³⁺ ions and Europium Eu³⁺ ions greater than five mole percent.

16. The lamp assembly according to claim 10, wherein the concentration of the Terbium Tb³⁺ ions and Europium Eu³⁺ ions in the doped glass is approximately equal.

17. The lamp assembly according to claim 10, wherein the doped glass is further doped with at least one of a rare earth element and a transition metal.

18. The lamp assembly according to claim 17, wherein the doped glass is further doped with at least one of Samarium (Sm³⁺), Praseodymium (Pr³⁺), Dysprosium (Dy³⁺), Thulium (Tm³⁺), Iron (Fe²⁺), and Iron Fe³⁺.

19. The lamp assembly according to claim 10, wherein the doped glass reduces transmission of short-wave infrared radiation having wavelengths from about 1.8 μm to about 2.5 μm and does not appreciably reduce transmission of visible light having wavelengths from about 0.4 μm to about 0.8 μm.

20. The lamp assembly according to claim 10, wherein the doped glass is disposed as a coating on a substrate comprising the substantially transparent face of the lamp housing.

21. The lamp assembly according to claim 10, wherein the doped glass comprises the substantially transparent face of the lamp housing.

22. The lamp assembly according to claim 10, wherein the doped glass comprises a window proximate to the substantially transparent face of the lamp housing.

23. The lamp assembly according to claim 10, wherein the lamp comprises an aircraft landing light.
